(19) United States
(12) Patent Application Publication
(10) Pub. No.: US 2017/0280939 A1
(43) Pub. Date: Oct. 5, 2017

(54) WHISK AND BEATER BATTER SAVING TOOL

(71) Applicants: Stephen John Weber, Charleston, WV (US); Madeleine Baxter Weber, Charleston, WV (US)

(72) Inventors: Stephen John Weber, Charleston, WV (US); Madeleine Baxter Weber, Charleston, WV (US)

(21) Appl. No.: 15/346,969

(22) Filed: Nov. 9, 2016

Related U.S. Application Data
(60) Provisional application No. 62/317,708, filed on Apr. 4, 2016.

(51) Int. Cl. A47J 43/28

(52) U.S. Cl. CPC A47J 43/288

(57) ABSTRACT

The disclosed technology regards a tool useful for cleaning whisks, beaters, and similar kitchen utensils, to effectively remove batter, frosting and other food from the prongs or tines thereof. The technology includes a longitudinally extending handle and three prongs (a central prong and opposing outer prongs) which project longitudinally from, and coplanar with, a first end of the handle. In some embodiments a scraper spatula or other kitchen utensil extends longitudinally from an opposing or second end of the handle.

### BACKGROUND OF THE TECHNOLOGY

The disclosed technology regards a kitchen tool useful for cleaning whisks, beaters, and similar kitchen utensils having a plurality of tines. When using such utensils, batter, frosting or other food may stick to the tines; removal of this food can be difficult with spatula scrapers, and often residual material remains on the tines and wasted when removed by water in the cleaning process. Therefore there is a need for a kitchen tool that efficiently and effectively removes batter and other materials from the tines of whisks, beaters and similar kitchen utensils, reducing the amount of residual material discarded.

### GENERAL DESCRIPTION OF THE TECHNOLOGY

The disclosed technology regards a tool useful for cleaning whisks, beaters, and similar kitchen utensils, to effectively remove batter, frosting and other food for use and cleaning. The technology includes a longitudinally extending handle and three prongs (a central prong and opposing outer prongs) which project longitudinally from, and coplanar with, a first end of the handle. In some embodiments the technology includes four prongs. The prongs are designed to easily fit between a variety of whisk and beater tines. In some embodiments a kitchen utensil such as a scraper spatula or spoon extends longitudinally from an opposing or second end of the handle.

The handle of the disclosed technology is generally rectangular in shape, with rounded or angular edges; alternatively, a cylindrical handle may be used. The prongs of the disclosed technology have sufficient rigidity to reach between the tines and push dough, frosting or other material, from the area between the tines. The prongs may be generally cylindrical, or may have an oval or a convex polygon cross section. The prongs may have a decreasing cross-sectional area from their proximal end (the point of affixation to the handle) to their distal end, and the distal ends may be tapered. In some embodiments the central prong extends a length from the handle greater than the extending length of the opposing outer prongs.

The prongs of the disclosed technology may be removably secured or permanently affixed to the first end of the handle by coupling means. One end of the coupling means may have apertures to receive a proximal end of each prong, and the opposing end may have an aperture for receiving a receded portion of the first end of the handle.

The components of the disclosed technology as described herein may be molded from a single mold to form a unitary structure, or may be separately molded with the components affixed or removably affixed one to another. Further, the prongs and the handle may a surface made from silicone rubber, with or without a reinforced core.

By this configuration and arrangement, as recited in the claims, shown in the drawings and described in the present disclosure generally and through alternative embodiments, a kitchen tool is presented that efficiently and effectively removes batter, frosting and other food products from the tines of whisks, beaters and similar kitchen utensils, reducing the amount of residual material discarded.

### DESCRIPTION OF THE DRAWINGS

The disclosed will be better understood by way of example with reference to the accompanying drawings in which:

FIG. 1 depicts a top view of an embodiment of the disclosed technology.

FIG. 2 depicts a side view of the embodiment of the disclosed technology shown in FIG. 1.

FIG. 3 depicts a peripheral view of the embodiment of the disclosed technology shown in FIG. 1.

FIG. 4 depicts a peripheral view of an embodiment of the coupling means and prongs of the disclosed technology.

FIG. 5 depicts an end view of an embodiment of the coupling means of the disclosed technology.

FIG. 6 depicts a top view of the embodiment of the coupling means and prongs of the disclosed technology shown in FIG. 4.

FIG. 7 depicts a second end view of an embodiment of the coupling means of the disclosed technology.

FIG. 8 depicts a side view of the embodiment of the coupling means and prongs of the disclosed technology shown in FIG. 4.

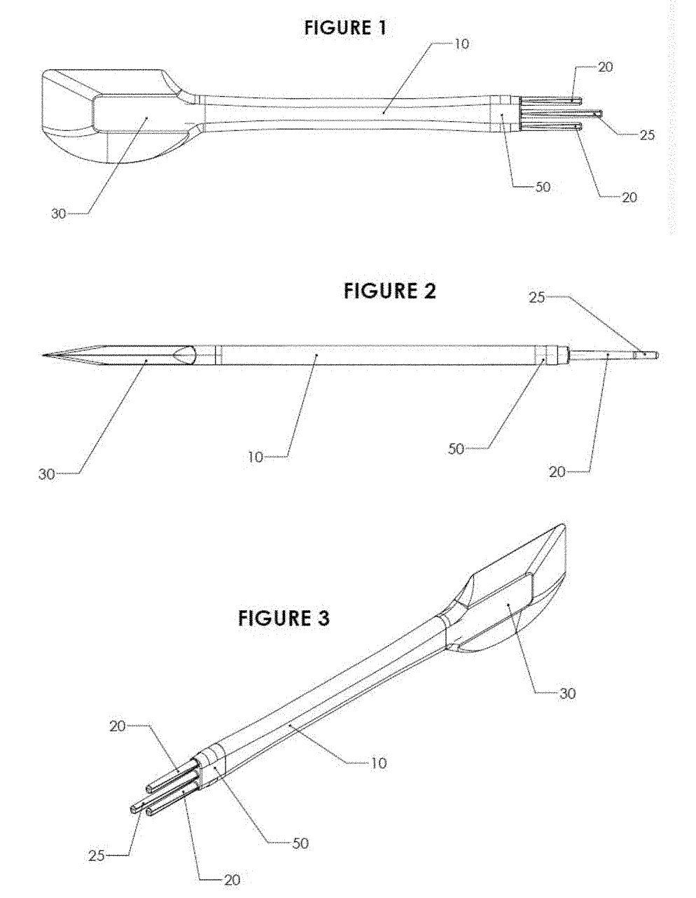

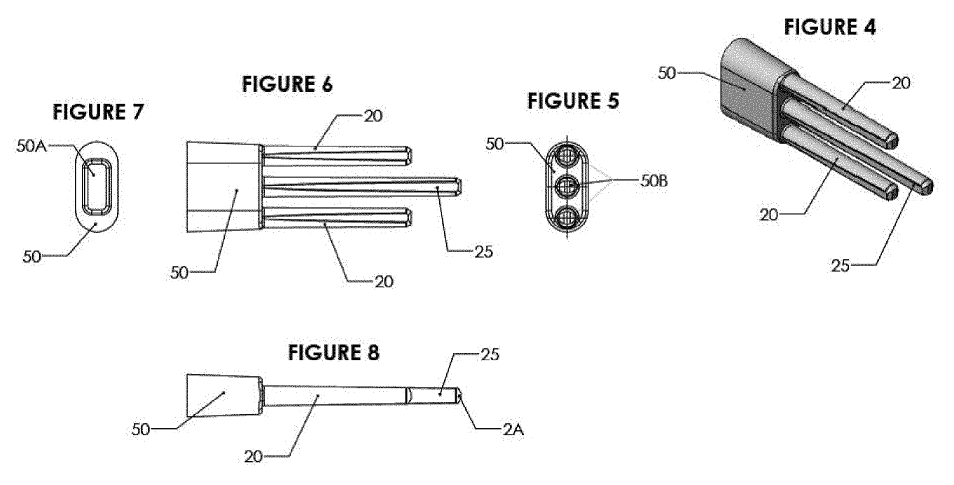

### DETAILED DESCRIPTION OF THE DISCLOSED TECHNOLOGY

As shown in the Figures, the disclosed technology includes a longitudinally extending handle 10 and three prongs (a central prong 25 and opposing outer prongs 20) which project longitudinally from, and coplanar with, a first end of the handle. In some embodiments (not shown), the technology includes four prongs. In some embodiments a scraper spatula 30 extends longitudinally from an opposing or second end of the handle. The scraper spatula may have a generally flat blade portion which extends longitudinally and may extend laterally from the second end of the handle; however, any scraper spatula design would be suitable for use with the disclosed technology. In other embodiments a spoon or other kitchen utensil may extend from the second end of the handle.

The handle 10 of the disclosed technology is generally rectangular in shape, with rounded or angular edges; however, other shapes such as a cylindrical shape may be used. In the embodiments shown, the handle has a length of about between about 5″ and 8″, or about 7″. In some embodiments the first end of the handle has a width greater than width at its longitudinal midpoint.

The prongs 20, 25 of the disclosed technology may have a cross section which is generally circular, oval, or a convex polygon. In some embodiments the prongs 20, 25 have a diameter at their proximal end (the point of affixation to the handle) of between about 0.15″ and 0.25″, or about 0.2″; in these and other embodiments the prongs may have a decreasing cross-sectional area from their proximal end to their distal end, wherein an angle defining the decrease of the cross-sectional area of each prong may be from between about 0.05 degrees to 2 degrees or about 0.7 degrees from the central axis of each prong. The prongs may have tapered distal ends 2A, the tapered ends having a length of between about 0.05″ to 0.4″, or about 0.29″, and an angle of taper of between 25 degrees and 35 degrees, or about 30 degrees.

In some embodiments the central prong 25 extends a length from the handle 10 greater than the extending length of the opposing outer prongs 20; in other embodiments (not shown) the prongs have equal length. For example, the central prong 25 may have a length from the handle of between about 1.5″ to 2.5″, or about 2″, and the opposing outer prongs may each have a length of between about 1″ to 2″, or about 1.5″ from the handle. In some embodiments the central axis of each of the outer prongs 20 is spaced apart from the central axis of the center prong 25 by between about 0.2″ and 0.5″, or about 0.31″.

The prongs of the disclosed technology have sufficient rigidity to reach between the tines and push dough, frosting or other material, from the area between the tines.

In some embodiments the prongs 20, 25 of the disclosed technology are removably secured or permanently affixed to the first end of the handle 10 by coupling means 50. In the embodiment shown in FIGS. 6 and 7, the coupling means 50 has on one end apertures 50B to receive a proximal end of each prong, and on an opposing end a channel 50A for receiving a recessed end of the first end of the handle. In another embodiment, the handle 10 comprises a channel for receiving a recessed end of the coupling means 50. In either embodiment the external surface of the coupling means is flush with the external handle surface at its first end. In other embodiments the coupling means may sit above the external handle surface.

As shown in FIG. 9, in some embodiments the coupling means 50 has top and bottom surfaces, tapered from the point of coupling with the handle to the point of coupling with the prongs by between about 1 degree and 4 degrees, or about 2 degrees, from the central longitudinal axis of the handle. The coupling means may be generally rectangular, with curved edges, having a width of between about 0.3″ and 0.5″, or about 0.425″, a length of between about 0.5″ and 1″, or about 0.75″, wherein the radius of curvature of the edges is between about 0.1 degrees and 0.3 degrees, or about 0.2 degrees.

All or some of the handle 10, the prongs 20, 25, the coupling means 50, and the spatula scraper 30 or other kitchen utensils may be formed from a single mold to form a unitary structure, or may be separately molded with the components affixed or removably affixed. When all elements of the disclosed technology are formed as a single unit, the coupling means is incorporated into the handle, and the prongs extend therefrom, without need for apertures as hereinabove described. In some embodiments an aperture can extend through the handle to allow the tool to be hung on a nail when not in use.

Any and all of the coupling means 50, the spatula scraper 30 or other kitchen utensil, the prongs 20, 25 and the handle 10 may have a surface made from rubber, such as a silicone rubber, or a Polytetrafluoroethylene (PTFE) such as Teflon™. In some embodiments the prongs 20, 25 and/or the handle 10 may have a surface material and a reinforced core, wherein the reinforced core is made from a material (e.g. plastic or wood) more rigid than the surface material. In some embodiments the handle 10 and/or the prongs 20, 25 are made from wood or metal.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A kitchen tool comprising:
a longitudinally extending handle having a first end and a second end; and
three prongs, comprising a central prong and opposing outer prongs, the prongs projecting longitudinally from and coplanar with the first end of the handle.

2. The kitchen tool of claim 1, further comprising a spatula scraper extending longitudinally from a second end of the handle, the spatula scraper having a generally flat blade portion.

3. The kitchen tool of claim 1, wherein the handle is generally rectangular in shape, with a width at the first end greater than a width at its longitudinal midpoint.

4. The kitchen tool of claim 1, wherein the prongs are generally cylindrical.

5. The kitchen tool of claim 4, wherein the prongs have a diameter of between about 0.15″ and 0.25″.

6. The kitchen tool of claim 1, wherein the central prong extends a length from the handle greater than a length extended from the handle of the opposing outer prongs.

7. The kitchen tool of claim 1, wherein the central prong has a length of between about 1.5″ and 2.5″, and the opposing outer prongs each have a length of between about 1″ and 2″.

8. The kitchen tool of claim 1, wherein each of the prongs comprises a tapered distal end, the tapered end having a length of between about 0.05″ and 0.4″, and an angle of taper of between about 25 degrees and 35 degrees.

9. The kitchen tool of claim 1, wherein each of the prongs has a decreasing cross-sectional area from a proximal prong end to a distal prong end.

10. The kitchen tool of claim 9, wherein an angle defining the decrease of the cross-sectional area of each prong is between about 0.05 degrees and 0.5 degrees from a central axis of each prong.

11. The kitchen tool of claim 1, wherein a central axis of each of the outer prongs is spaced apart from the central axis of the center prong by between about 0.2″ and 0.5″.

12. The kitchen tool of claim 1, wherein the prongs are secured to the first end of the handle by coupling means.

13. The kitchen tool of claims 12, wherein the coupling means has three apertures on one end to receive a proximal end of each prong, and a channel on an opposing end for receiving the first end of the handle.

14. The kitchen tool of claim 12, wherein the coupling means comprises top and bottom surfaces, and wherein each of the top and bottom surfaces is tapered by between about 1 degree and 4 degrees from the central longitudinal axis of the handle.

15. The kitchen tool of claim 12, wherein the coupling means is generally rectangular with curved edges, having a width of between about 0.3″ and 0.5″, a length of between about 0.5″ and 1″ and wherein the coupling means comprises rounded edges having a radius of curvature of between about 0.1 degrees and 0.3 degrees.

16. The kitchen tool of claim 12, wherein the coupling means is removably affixed to the handle.

17. The kitchen tool of claim 1, wherein the handle has a length of about between about 5″ and 8″.

18. The kitchen tool of claim 1, wherein the handle and the prongs are molded from a single mold to form a unitary structure.

19. The kitchen tool of claim 1, wherein the prongs and the handle have a surface made from silicone rubber.

20. The kitchen tool of claim 1, wherein the prongs and the handle each has a surface material and a reinforced core, wherein the reinforced core is made from a material more rigid than the surface material.
